(19) United States
(12) Patent Application Publication
(10) Pub. No.: US 2022/0352496 A1
(43) Pub. Date: Nov. 3, 2022

(54) METHOD AND APPARATUS FOR FABRICATING AN ELECTRODE FOR A BATTERY

(71) Applicant: GM GLOBAL TECHNOLOGY OPERATIONS LLC, Detroit, MI (US)

(72) Inventors: Leng Mao, Troy, MI (US); Anil K. Sachdev, Rochester Hills, MI (US)

(73) Assignee: GM GLOBAL TECHNOLOGY OPERATIONS LLC, Detroit, MI (US)

(21) Appl. No.: 17/242,616

(22) Filed: Apr. 28, 2021

(51) Int. Cl. H01M 4/134; H01M 4/04; H01M 4/1395; H01M 50/46; H01M 4/66; H01M 4/38; H01M 4/74; H01M 10/052; H01M 50/531

(52) U.S. Cl. CPC H01M 4/134; H01M 4/043; H01M 4/1395; H01M 4/0471; H01M 4/0404; H01M 50/46; H01M 4/662; H01M 4/669; H01M 4/382; H01M 4/747; H01M 4/667; H01M 10/052; H01M 50/531; H01M 2004/021

(57) ABSTRACT

A battery electrode, and a method for fabricating the battery electrode are described. The battery electrode includes a lithium foil that is arranged between a first porous current collector and a second porous current collector. The first and second porous current collectors each defines a multiplicity of interstitial spaces, and the lithium foil is embedded in the interstitial spaces defined by the first porous current collector and in the interstitial spaces defined by the second porous current collector, thus enabling two-side functionality.

Lithium ion battery packs may include one or multiple lithium ion battery cells that are electrically connected in parallel or in series, depending upon the needs of the system. Each battery cell includes one or a plurality of lithium ion electrode pairs that are enclosed within a sealed pouch envelope. Each electrode pair includes a negative electrode (anode), a positive electrode (cathode), and a separator that physically separates and electrically isolates the negative and positive electrodes. To facilitate lithium ion mobility, an electrolyte that conducts lithium ions may be present within the separator. The electrolyte allows lithium ions to pass through the separator between the positive and negative electrodes to counterbalance the flow of electrons that, during charge and discharge cycles of the lithium ion battery cell, circumvent the separator and move between the electrodes through an external circuit. Depending on their chemistry, each lithium ion battery cell has a maximum or charging voltage (voltage at full charge) due to the difference in electrochemical potentials of the electrodes. For example, each lithium ion battery cell may have a charging voltage in the range of 3V to 5V and a nominal open circuit voltage in the range of 2.9V to 4.2V.

Each electrode pair is configured to electrochemically store and release electric power. Each negative electrode has a current collector with a negative foil that is coupled to a negative terminal tab, and each positive electrode has a current collector with a positive foil that is coupled to a positive terminal tab. Within each battery cell, the negative terminal tab electrically communicates with the negative current collectors that contact and exchange electrons with the negative electrodes of the electrode pairs, and the positive terminal tab electrically communicates with the positive current collectors that contact and exchange electrons with the positive electrodes of the electrode pairs. Lithium-ion battery cells are capable of being discharged and re-charged over many cycles.

There are benefits to having an improved current collector for an electrode, and to having manufacturing processes associated with fabricating an improved current collector.

### SUMMARY

A battery electrode, and a method for fabricating the battery electrode are described. The concepts described herein provide for a negative electrode that is a lithium foil that is sandwiched between two collectors that are fabricated as metal meshes or as perforated foils. Soft lithium in the lithium foil is urged into the voids of the metal meshes, and is thus accessible from either side. This allows for a fabrication process that includes a continuous roll-to-roll processing to achieve two-sided electrolyte access. The anode is made with a simple roll compression step, with the lithium being accessible from both sides with the two meshes being in a sandwich configuration. Voids that remain on the two surfaces of the mesh electrode provide volume or space for electrolyte and for the lithium ions to deposit during charge, and minimize or prevent volume change of the anode during charge/discharge cycles.

The metal mesh surface provides additional area and greatly reduces the current density/Li⁺ ion flux, which reduces dendrite growth to enhance fast charging capability. A stable Solid Electrolyte Interface (SEI) may be formed at the interface between the mesh surface and the separator, which may serve to improve durability. Furthermore, a lower surface quality and higher lithium foil thickness can be used to reduce material cost.

An aspect of the disclosure includes a battery electrode in the form of a lithium foil that is arranged between a first porous current collector and a second porous current collector. The first and second porous current collectors each defines a multiplicity of interstitial spaces, and the lithium foil is embedded in the interstitial spaces defined by the first porous current collector and in the interstitial spaces defined by the second porous current collector, thus enabling two-side functionality.

Another aspect of the disclosure includes the lithium foil embedded in the interstitial spaces of a first portion of the first porous current collector and in the interstitial spaces of a first portion of the second porous current collector. An electrical connection tab arranged on second portions of the first and second porous current collectors.

Another aspect of the disclosure includes each of the first and second porous current collectors being composed of metallic strands that are arranged to form a mesh sheet that defines the multiplicity of interstitial spaces.

Another aspect of the disclosure includes the metallic strands being fabricated from one of stainless steel or a copper alloy.

Alternatively, the metallic strands may be fabricated from one silver, nickel, zinc, tin, or alloys thereof.

Another aspect of the disclosure includes the metallic strands having circular cross-sections that have been flattened after having been woven into the woven mesh sheet.

Another aspect of the disclosure includes the first and second porous current collectors being metallic sheets fabricated from one of stainless steel or a copper alloy, wherein the interstitial spaces have a multiplicity of perforations therein.

Another aspect of the disclosure includes diameters of the multiplicity of perforations ranging between 10 microns and 1000 microns.

Another aspect of the disclosure includes a first separator arranged on a first side of the battery electrode and a second separator arranged on a second side of the battery electrode.

Another aspect of the disclosure includes the battery electrode being an anode.

Another aspect of the disclosure includes a method for fabricating a battery electrode that includes arranging a lithium foil between a first porous current collector and a second porous current collector, wherein the first and second porous current collectors each define a multiplicity of interstitial spaces. The lithium foil, the first porous current collector and the second porous current collector are merged to embed the lithium foil in the multiplicity of interstitial spaces defined by the first porous current collector and in the multiplicity of interstitial spaces defined by the second porous current collector. The lithium foil, the first porous current collector and the second porous current collector are joined and passivated.

Another aspect of the disclosure includes the first porous current collector and the second porous current collector being first and second mesh sheets that are composed of woven metallic strands.

Another aspect of the disclosure includes the first porous current collector and the second porous current collector being first and second sheets fabricated from one of stainless steel or a copper alloy, and wherein the multiplicity of the interstitial spaces are a multiplicity of perforations therein.

Another aspect of the disclosure includes merging the lithium foil, the first porous current collector and the second porous current collector by compressing the lithium foil between the first porous current collector and the second porous current collector.

Another aspect of the disclosure includes applying a coating onto the first porous current collector and the second porous current collector prior to arranging the lithium foil between the first porous current collector and the second porous current collector.

Another aspect of the disclosure includes warming the lithium foil, the first porous current collector and the second porous current collector prior to compressing the lithium foil, the first porous current collector and the second porous current collector, wherein warming by heating the lithium foil, the first porous current collector and the second porous current collector to a temperature of up to 180 C.

Another aspect of the disclosure includes joining the lithium foil, the first porous current collector and the second porous current collector by heating the lithium foil, the first porous current collector and the second porous current collector to a temperature having a range between 180 C and 200 C in an atmosphere that is inert to lithium.

Another aspect of the disclosure includes passivating the lithium foil, the first porous current collector and the second porous current collector by coating the lithium foil, the first porous current collector and the second porous current collector with an antioxidant material.

Another aspect of the disclosure includes arranging a first separator on a first side of the battery electrode and arranging a second separator on a second side of the battery electrode; and compressing the first and second separators and the battery electrode.

Another aspect of the disclosure includes compressing, via a first pair of opposed rollers, a first mesh sheet composed of woven metallic strands to form a first porous current collector, and compressing, via a second pair of opposed rollers, a first mesh sheet composed of woven metallic strands to form a second porous current collector. A lithium foil is arranged between the first porous current collector and the second porous current collector, wherein the first and second porous current collectors each define a multiplicity of interstitial spaces. The lithium foil, the first porous current collector and the second porous current collector are merged to embed the lithium foil in the multiplicity of interstitial spaces defined by the first porous current collector and in the multiplicity of interstitial spaces defined by the second porous current collector. The lithium foil, the first porous current collector and the second porous current collector are joined and passivated.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows an exploded isometric view of a battery cell that includes positive and negative battery tabs and an electrode pair that are arranged in a stack, in accordance with the disclosure.

FIGS. 2A and 2B schematically illustrate a top-view and a cross-sectional end-view, respectively, of an embodiment of an anode current collector, in accordance with the disclosure.

FIG. 3 pictorially shows an embodiment of a process for fabricating an electrode for a battery cell, in accordance with the disclosure.

FIG. 4 pictorially shows another embodiment of a process for fabricating an electrode for a battery cell, in accordance with the disclosure.

FIG. 5 pictorially shows an embodiment of a portion of a process for fabricating an electrode for a battery cell, in accordance with the disclosure.

FIGS. 6A-6D schematically illustrate cross-sectional cutaway top views and corresponding cross-sectional cutaway side views of a portion of an electrode for a battery cell, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be employed to assist in describing the drawings. These and similar directional terms are illustrative, and are not to be construed to limit the scope of the disclosure. Furthermore, the disclosure, as illustrated and described herein, may be practiced in the absence of an element that is not specifically disclosed herein.

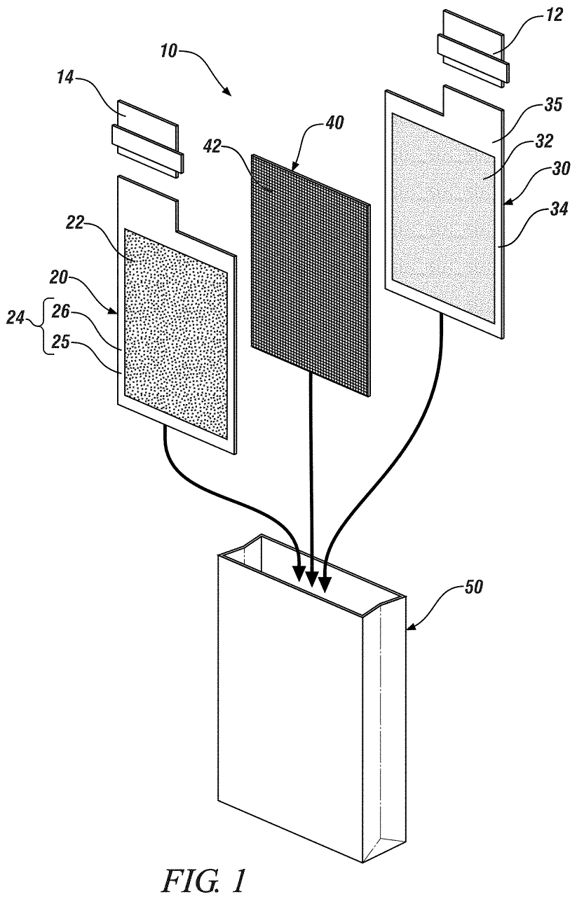

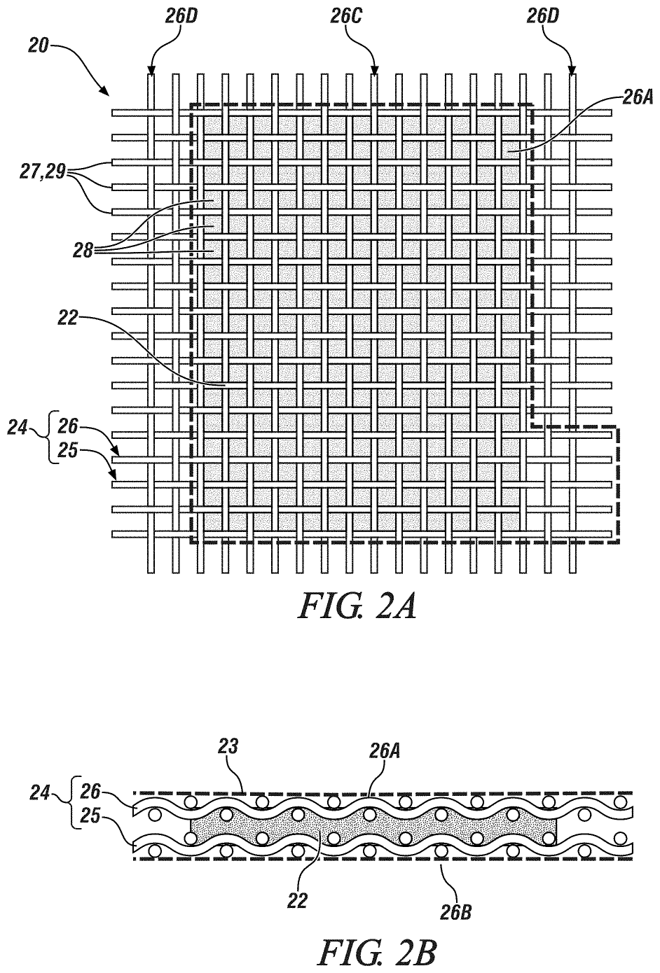

Referring to the drawings, wherein like reference numerals correspond to like or similar components throughout the several Figures, FIGS. 1, 2A, and 2B schematically illustrate an embodiment of a prismatically-shaped lithium ion battery cell 10 that includes an anode 20, a cathode 30 and a separator 40 that are arranged in a stack and sealed in a flexible pouch 50 containing an electrolytic material 42. A first, negative battery cell tab 12 and a second, positive battery cell tab 14 protrude from the flexible pouch 50. The terms “anode” and “negative electrode” are used interchangeably. The terms “cathode” and “positive electrode” are used interchangeably. A single pair of the anode 20, cathode 30 and separator 40 are illustrated. It is appreciated that multiple pairs of the anode 20, cathode 30 and separator 40 may be arranged and electrically connected in the flexible pouch 50, depending upon the specific application of the battery cell 10.

The anode 20 includes a first active material 22 that is arranged on an anode current collector 24 that is composed from a first mesh sheet 25 and a second mesh sheet 26, wherein the first and second mesh sheets 25, 26 are porous sheets on which the first active material 22 is merged, joined and/or otherwise combined. The anode current collector 24 has a foil portion that extends from the first active material 22 to form the first battery cell tab 12.

The cathode 30 includes a second active material 32 that is arranged on a cathode current collector 34, with the cathode current collector 34 having a foil portion 35 that extends from the second active material 32 to form the second battery cell tab 14.

The separator 40 is arranged between the positive and negative electrodes 30, 20 to physically separate and electrically insulate the positive and negative electrodes 30, 20 from each other. The electrolytic material 42 that conducts lithium ions is contained within the separator 40 and is exposed to each of the positive and negative electrodes 30, 20 to permit lithium ions to move between the positive and negative electrodes 30, 20. Additionally, the negative electrode 20 contacts and exchanges electrons with the anode current collector 24, and the positive electrode 30 contacts and exchanges electrons with the cathode current collector 34.

The negative electrode 20 and the positive electrode 30 of each electrode pair are fabricated as electrode material that is able to intercalate and deintercalate lithium ions. The electrode materials of the positive and negative electrodes 30, 20 are formulated to store intercalated lithium at different electrochemical potentials relative to a common reference electrode, e.g., lithium. In the construct of the electrode pair 20, the negative electrode 20 stores intercalated lithium at a lower electrochemical potential (i.e., a higher energy state) than the positive electrode 30 such that an electrochemical potential difference exists between the positive and negative electrodes 30, 20 when the negative electrode 20 is lithiated. The electrochemical potential difference for each battery cell 10 results in a charging voltage in the range of 3V to 5V and nominal open circuit voltage in the range of 2.9V to 4.2V. These attributes of the negative and positive electrodes 30, 20 permit the reversible transfer of lithium ions between the positive and negative electrodes 30, 20 either spontaneously (discharge phase) or through the application of an external voltage (charge phase) during operational cycling of the electrode pair 20. The thickness of each positive and negative electrode 30, 20 ranges between 30 um and 150 um.

The negative electrode 20 is a lithium host material such as, for example, graphite, silicon, or lithium titanate. The lithium host material may be intermingled with a polymeric binder material to provide the negative electrode 20 with structural integrity and, in one embodiment, a conductive fine particle diluent. The lithium host material is preferably graphite and the polymeric binder material is preferably one or more of polyvinylidene fluoride (PVdF), an ethylene propylene diene monomer (EPDM) rubber, styrene butadiene rubber (SBR), a carboxymethyl cellulose (CMC), polyacrylic acid, or mixtures thereof. Graphite is normally used to make the negative electrode 20 because, in addition to being relatively inert, its layered structure exhibits favorable lithium intercalation and deintercalation characteristics that help provide the battery electrode pair 20 with a desired energy density. Various forms of graphite that may be used to construct the negative electrode 20 are commercially available. The conductive diluent may be very fine particles of, for example, high-surface area carbon black.

The positive electrode 30 is composed as a lithium-based active material that stores intercalated lithium at a higher electrochemical potential (relative to a common reference electrode) than the lithium host material used to make the negative electrode 20. The same polymeric binder materials (PVdF, EPDM, SBR, CMC, polyacrylic acid) and conductive fine particle diluent (high-surface area carbon black) that may be used to construct the negative electrode 20 may also be intermingled with the lithium-based active material of the positive electrode 30 for the same purposes. The lithium-based active material is preferably a layered lithium transition metal oxide, such as lithium cobalt oxide, a spinel lithium transition metal oxide, such as spinel lithium manganese oxide, a lithium polyanion, such as a nickel-manganese-cobalt oxide, lithium iron phosphate, or lithium fluorophosphate. Some other suitable lithium-based active materials that may be employed as the lithium-based active material include lithium nickel oxide, lithium aluminum manganese oxide, and lithium vanadium oxide, to name examples of alternatives. Mixtures that include one or more of these recited lithium-based active materials may also be used to make the positive electrode 30.

The separator 40 is composed as one or more porous polymer layers that, individually, may be composed of any of a wide variety of polymers. Only one such polymer layer is shown here for simplicity. Each of the one or more polymer layers may be a polyolefin. Some specific examples of a polyolefin are polyethylene (PE) (along with variations such as HDPE, LDPE, LLDPE, and UHMWPE), polypropylene (PP), or a blend of PE and PP. The polymer layer(s) function to electrically insulate and physically separate the negative and positive electrodes 20, 30. The separator 40 may further be infiltrated with a liquid electrolyte throughout the porosity of the polymer layer(s). The liquid electrolyte, which also wets both electrodes 20, 30, preferably includes a lithium salt dissolved in a non-aqueous solvent. The separator 40 has a thickness that may be between 10 um to 50 um.

The descriptions set forth above pertaining to the negative electrode 20, the positive electrode 30, the separator 40, and the electrolytic material 42 included within the separator 40 are intended to be non-limiting examples. Many variations on the chemistry of each of these elements may be applied in the context of the lithium ion battery cell 10 of the present disclosure. For example, the lithium host material of the negative electrode 20 and lithium-based active material of the positive electrode 30 may be compositions other than those specific electrode materials listed above, particularly as lithium ion battery electrode materials continue to be researched and developed. Additionally, the polymer layer(s) and/or the electrolyte contained within the polymer layer(s) of the separator 40 may also include other polymers and electrolytes than those specifically listed above. In one variation, the separator 40 may be a solid polymer electrolyte that includes a polymer layer—such polyethylene oxide (PEO), polypropylene oxide (PPO), polyacrylonitrile (PAN), or polyvinylidene fluoride (PVdF) having a lithium salt or swollen with a lithium salt solution. The electrode pair 20 reversibly exchanges lithium ions through the separator 40 and a flow of electrons around the separator 40 during applicable discharge and charge cycles.

The anode and cathode current collectors 24, 34 are thin metallic plate-shaped elements that contact their respective first and second active materials 22, 32 over an appreciable interfacial surface area. The purpose of the anode and cathode current collectors 24, 34 is to exchange free electrons with their respective first and second active materials 22, 32 during discharging and charging.

The cathode current collector 34 is a planar sheet that is fabricated from aluminum or an aluminum alloy, and has a thickness at or near 0.2 mm.

FIGS. 2A and 2B schematically illustrate a top view and end view, respectively, of the anode 20, including the first active material 22 embedded and joined to the first mesh sheet 25 and the second mesh sheet 26 of the current collector 24. The first mesh sheet 25 being arranged in parallel with and overtop of the second mesh sheet 26. The first mesh sheet 25 and the second mesh sheet 26 are each composed as a multiplicity of metallic strands 27 that are woven, stitched or otherwise arranged to form a mesh that defines a multiplicity of interstitial spaces 28 in the form of gaps, voids, etc. The first active material 22 is embedded in the interstitial spaces 28 of the first and second mesh sheets 25, 26. The surface of the first active material 22 is arranged so that it does not extend outside of an outer plane 23, which is a mesh height that is defined by an outer portion of the first and second mesh sheets 25, 26 on a first (top) surface 26A or a second (bottom) surface 26B.

The anode current collector 24 has a rectangularly-shaped planar shape in one embodiment, and has the first, top surface 26A, the second, bottom surface 26B, a center portion 26C, and leftward and rightward longitudinal edges 26D. Alternatively, the anode current collector 24 may be circularly-shaped, or another shape that conforms to a specific application need. The metallic strands 27 are fabricated from stainless steel, copper, a copper alloy, a nickel-coated copper, or another material and are woven, stitched or otherwise arranged to form the respective one of the first and second mesh sheets 25, 26. In one embodiment, the first and second mesh sheets 25, 26 each has a thickness at or near 0.2 mm.

Alternatively, the first mesh sheet 25 and the second mesh sheet 26 are replaced with first and second solid sheets fabricated from copper alloys, alloys, stainless steel, etc., and having a plurality of apertures formed on the surfaces thereof.

The diameter of the metallic strands 27 ranges between 10 microns and 500 microns, and the multiplicity of interstitial spaces 28 defined by the metallic strands 27 have maximum opening sizes that may range between a factor of one times and ten times the diameter of the metallic strands 27. The metallic strands 27 have circular cross-sections in one embodiment. Alternatively, the metallic strands 27 have rectangular cross-sections. Alternatively, the metallic strands 27 have oval cross-sections. Alternatively, the metallic strands 27 have circular cross-sections that have been flattened by a compressive force after having been woven into the first and second mesh sheets 25, 26, as illustrated with reference to FIG. 4. In one embodiment, the metallic strands 27 have a coating 29 that assists in securing the first active material 22 that is embedded in the interstitial spaces 28 onto the metallic strands 27.

The coating 29 may be applied onto the metallic strands 27 prior to being fabricated into the first and second mesh sheets 25, 26 in one embodiment. Alternatively, the coating 29 may be applied onto the first and second mesh sheets 25, 26 during fabrication. In one embodiment, the coating 29 is one of tin, nickel, or silver, or alloys thereof. Alternatively, the coating 29 may be metals (e.g., Ni, Zn, Sn, Au, Ag, Cu) and their Li-intermetallic phase, metal oxides (e.g., ZnO, CuO, Al2O3, SiO2, etc), nitrogen-doped graphite, carbon nitrite, and polymer materials such as PEO-based polymer, Lithium Lanthanum Titanate (LLTO), Lithium Lanthanum Zirconate (LLZO), Lithium Aluminum Titanium Phosphate (LATP), Lithium Phosphorus Sulfide (LPS), Lithium Phosphorus Sulfur Chloride Iodide (LPSCI), among others.

The wettability of the first active material 22 onto the first and second mesh sheets 25, 26 can be tuned by tuning parameters of the wire mesh, including tuning the wire mesh pitch, the strand diameter, the strand cross-section shape, the strain orientation, and mesh topology, i.e., woven mesh or knitted mesh. The size of the interstitial spaces 28 affects capillary forces and the ability to embed and join the applied lithium: if the gaps are too large, molten lithium may droop or fall out; if too narrow, there may be a need for an aggressive wetting agent to achieve sufficient coverage of the lithium onto the first and second mesh sheets 25, 26.

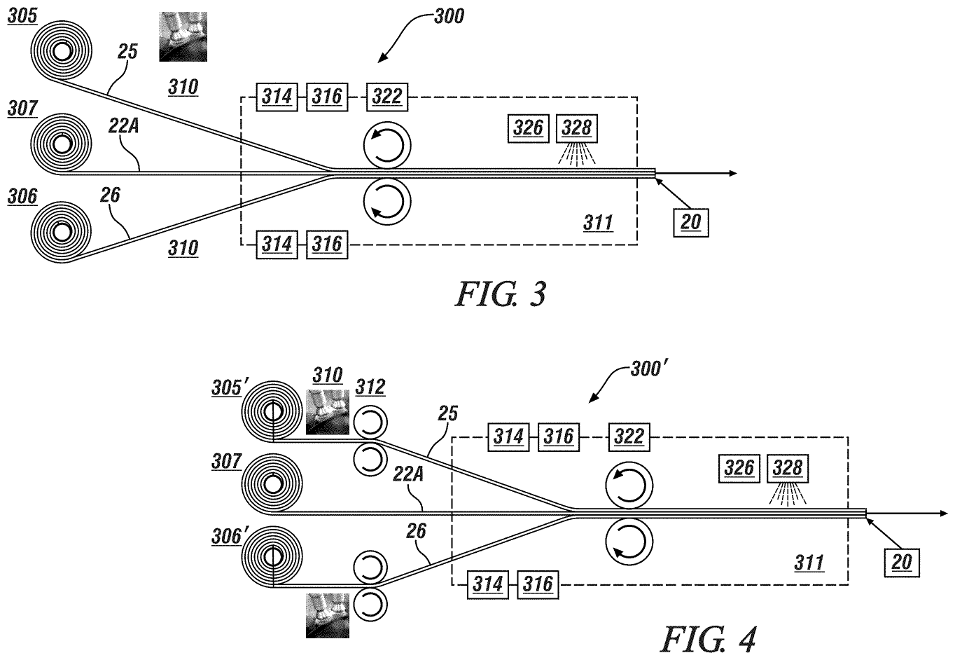

FIG. 3 schematically illustrates an embodiment of an anode fabrication process (process) 300 for forming an embodiment of the anode 20 that is described with reference to FIGS. 1, 2A, and 2B, wherein the anode 20 includes the first active material 22 arranged on the anode current collector 24 that is composed of the first and second mesh sheets 25, 26. The first active material 22 is embedded in the interstitial spaces 28 of the first and second mesh sheets 25, 26 and joined to the surfaces of the first and second mesh sheets 25, 26. In one embodiment, and as described herein, the first active material 22 is prepared as a lithium foil 22A that is arranged on a spool.

Raw material is fed from a first spool 305 and a second spool 306, or from another feed mechanism into processing equipment, wherein the raw material is in the form of the first mesh sheet 25 and the second mesh sheet 26, respectively. The first and second mesh sheets 25, 26 are subjected to a cleaning step (Step 310) to remove debris and other materials from their surfaces prior to passing into an environmental chamber 311 that provides an atmosphere that is inert to lithium to prevent and avoid oxidation of the lithium. In one embodiment, the atmosphere in the environmental chamber 311 is free from oxygen. In one embodiment, the atmosphere in the environmental chamber 311 contains argon.

Raw material is also fed from a third spool 307 into the environmental chamber 311, wherein this raw material includes the first active material 22 that is arranged as the lithium foil 22A. The lithium foil 22A need not be continuous. The feeds from the first, second, and third spools 305, 306, and 307 are arranged in parallel.

After entering the environmental chamber 311, the first mesh sheet 25, the second mesh sheet 26, and the lithium foil 22A are subjected to warming (Step 314), wherein warming includes heating to a temperature up to 180 C.

Following the warming step (Step 314), the first mesh sheet 25 and the second mesh sheet 26 are coated with a coating 29 (Step 316). This may include coating the first mesh sheet 25 and the second mesh sheet 26 with tin, nickel, or silver, or an alloys thereof, prior to joining with the first active material 22. The addition of the coating 29 is intended to remove oxidized metal from the surfaces, seal out air thus preventing further oxidation, and facilitate amalgamation by improving surface wetting characteristics. The coating 29 also protects the metal surfaces from re-oxidation during soldering and helps the soldering process by altering the surface tension of the molten solder. As previously described, the coating 29 is composed of a base material and an activator which is the chemical that promotes better wetting of the solder by removing oxides from the metal surface. The coating process (Step 316) improves the wettability of the surfaces of the first mesh sheet 25 and the second mesh sheet 26 in relation to the subsequently joined first active material 22.

The coating process (Step 316) may be accomplished by immersing the first mesh sheet 25 and the second mesh sheet 26 in baths including one of tin, nickel, or silver, or an alloy thereof, or by a process of flash plating. Alternatively, the coating 29 may be applied to the first mesh sheet 25 and the second mesh sheet 26 and/or the individual wires thereof during fabrication of the first mesh sheet 25 and the second mesh sheet 26 prior to this process 300. Processes for applying the coating 29 to the first and second mesh sheets 25, 26 include electro-deposition, physical vapor deposition, chemical vapor deposition, plasma spray coating, etc.

The coating 29 may be any one of or combinations of metals (Ni, Zn, Sn, Au, Ag, Cu) and their Li-intermetallic phase, metal oxides (ZnO, CuO, Al2O3, SiO2, etc), Nitrogen-doped graphite, carbon nitrite, and polymer materials such as PEO-based polymer, Lithium Lanthanum Titanate (LLTO), Lithium Lanthanum Zirconate (LLZO), Lithium Aluminum Titanium Phosphate (LATP), Lithium Phosphorus Sulfide (LPS) Lithium Phosphorus Sulfur Chloride Iodide (LPSCI), etc.)

The lithium foil 22A is prepared, in one embodiment, as a thixotropic paste of having a stabilized particulate including lithium that is formed into a thin sheet.

The lithium foil 22A is placed between the first mesh sheet 25 and the second mesh sheet 26 and is merged by compressing the lithium foil 22A therebetween (Step 322). This step embeds the lithium foil 22A in the multiplicity of interstitial spaces 28 defined by the first mesh sheet 25 and the second mesh sheet 26, i.e., in the multiplicity of interstitial spaces 28 defined by the first porous current collector and the second porous current collector.

The lithium foil 22A is embedded, with the thickness of the lithium foil 22A being controlled so that the lithium foil 22A is suspended in the meshes of the first and second mesh sheets 25, 26 at or below the mesh height defined by the outer planes 23, as shown and described with reference to FIG. 2B.

Referring again to FIG. 3, the applied and embedded lithium is joined, i.e., fused or bonded, onto the first mesh sheet 25 and the second mesh sheet 26 of the anode current collector 24 by applying heat to melt the lithium powder contained in the lithium foil 22A, causing it to fuse with, adhere to or otherwise bond with the first mesh sheet 25 and the second mesh sheet 26 in the interstitial spaces 28 (Step 326). Heating to join the lithium includes heating, in the inert environment, the first mesh sheet 25 and the second mesh sheet 26 to a temperature that is in a temperature range between 180 C and 200 C. In one embodiment, the heating step is for a period of time of 30 minutes or less. Heating may be accomplished by a thermoelectric furnace, an infrared heat source, a resistance heating device, an induction heating device, or another heat generating device.

Following the heating step (Step 326), the anode 20 is subjected to passivation (Step 328), which includes applying an anti-oxidant material, such as a polymer substance, to outer surfaces of the anode 20 to avoid lithium oxidation. The passivation step (step 328) includes, in one embodiment, applying the anti-oxidant material in a spray form that is delivered by a sprayer (not shown). The temperature of the spray from the sprayer can be controlled to controllably cool the first mesh sheet 25 and the second mesh sheet 26 to manage physical contraction of the lithium and the first mesh sheet 25 and the second mesh sheet 26, thus minimizing or preventing distortion of the first mesh sheet 25 and the second mesh sheet 26 and minimizing or preventing separation of the lithium from the first mesh sheet 25 and the second mesh sheet 26. The resultant workpiece is an embodiment of the anode 20 that is described with reference to FIGS. 1, 2A, and 2B.

FIG. 4 schematically illustrates another embodiment of an anode fabrication process (process) 300′ for forming an embodiment of the anode 20 that is described with reference to FIGS. 1, 2A, and 2B. The anode fabrication process (process) 300′ is analogous to the anode fabrication process (process) 300 that is described with reference to FIG. 3. In this embodiment, raw material is fed from a first spool 305′ and a second spool 306′, or from another feed mechanism into processing equipment, wherein the raw material is in the form of the first mesh sheet 25 and the second mesh sheet 26, respectively. In this embodiment, the first and second mesh sheets 25, 26 are subjected to a cleaning step (Step 310) to remove debris and other materials from their surfaces and a compression step (Step 312) prior to passing into the environmental chamber 311 that provides an atmosphere that is inert to lithium. In the compression step (Step 312), the first and second mesh sheets 25, 26 are passed between two rollers to flatten the respective sheets. Thereafter, the process 300′ proceeds in a manner analogous to the process 300.

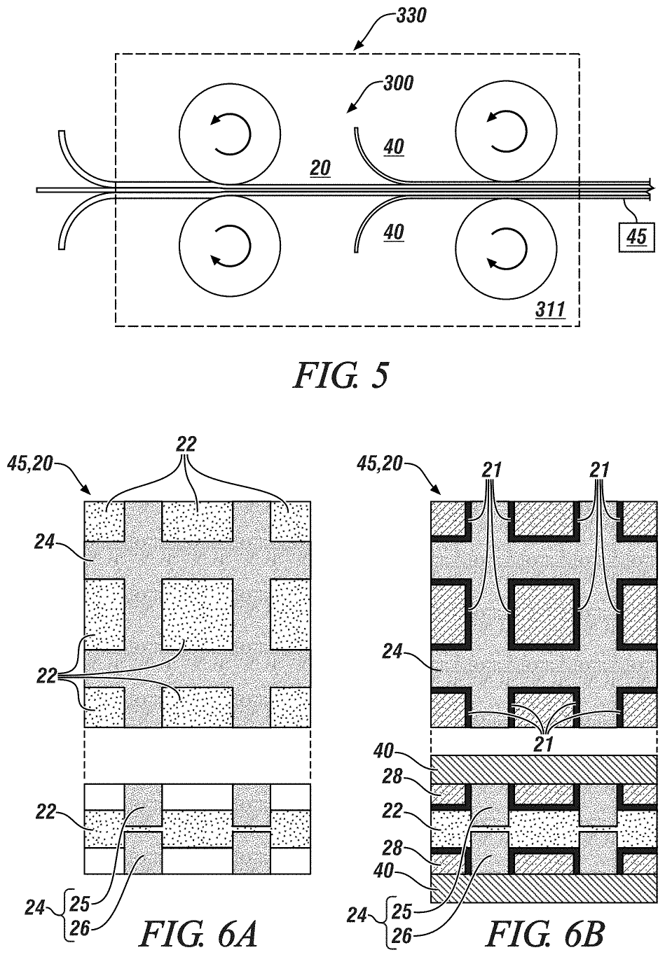

FIG. 5 schematically illustrates the process 300 with an added follow-on process step 330 to embed the separator 40 on both sides of the anode 20 (as shown) to form a separator-encased anode 45, wherein there is two-sided electrolyte access to the lithium in the anode 45. The lithium foil need not be continuous to avoid having lithium at folds. Alternatively, the added follow-on process step 330 embeds the separator 40 on a single side of the anode 20. The other steps of the process 300 remain unchanged.

In one embodiment, the follow-on process step 330 to embed the separator 40 on both sides of the anode 20 is executed in the environmental chamber 311 (as shown). Alternatively, the follow-on process step 330 to embed the separator 40 on both sides of the anode 20 is executed outside of the environmental chamber 311.

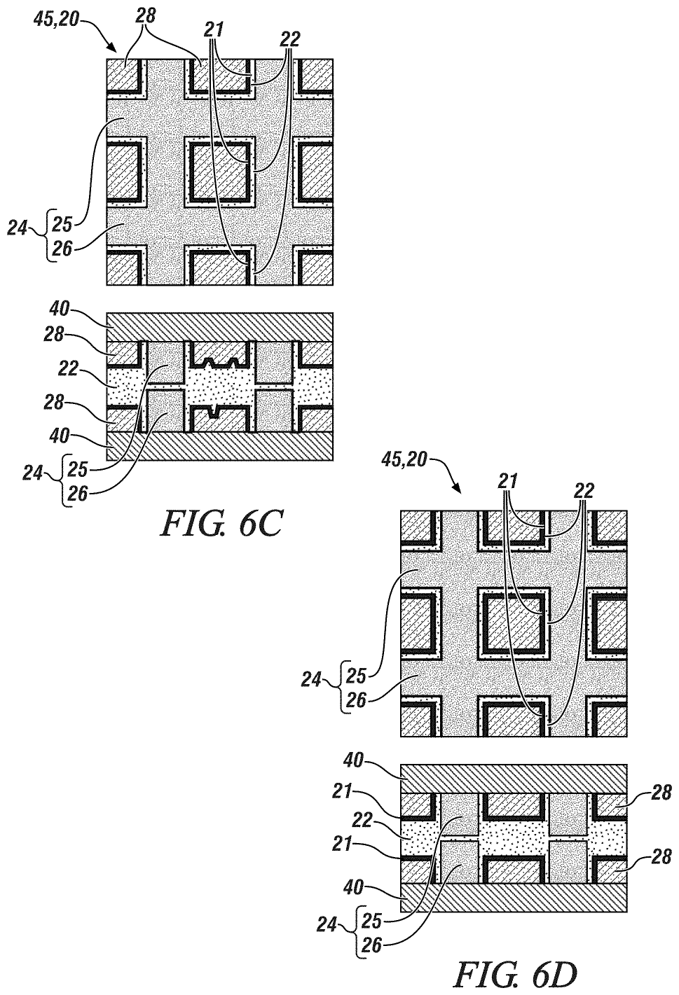

FIGS. 6A-6D schematically illustrate cross-sectional cutaway top views and corresponding cross-sectional cutaway side views of a portion of an embodiment of the electrode for a battery cell that is described herein.

FIG. 6A shows the merged electrode where the lithium is embedded in the multiplicity of interstitial spaces defined by the first meshes and in the multiplicity of interstitial spaces defined by the first meshes.

FIG. 6B shows that a Solid Electrolyte Interface (SEI) layer 21 that is formed on the mesh surface and lithium surface once the electrolyte fills the voids formed in the interstitial spaces of the mesh of the electrode.

FIG. 6C shows that lithium ion from the electrode is deposited in the interstitial spaces 28 on the surface of the mesh and lithium. The interstitial spaces 28 provide the space for lithium dendritic growth.

FIG. 6D shows that after multiple discharge/charge cycles, the stable SEI layer 21 forms on the mesh electrode at the interface between the mesh surface and the separator, which improves the cyclability of the cell 10, and thus may improve the service life of the cell 10.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A battery electrode, comprising:
a lithium foil arranged between a first porous current collector and a second porous current collector;
wherein the first porous current collector and the second porous current collector each defines a respective multiplicity of interstitial spaces; and
wherein the lithium foil is embedded in the interstitial spaces defined by the first porous current collector and in the interstitial spaces defined by the second porous current collector.

2. The battery electrode of claim 1:
wherein the lithium foil is embedded in the interstitial spaces of a first portion of the first porous current collector;
wherein the lithium foil is embedded in the interstitial spaces of a first portion of the second porous current collector; and
wherein an electrical connection tab arranged on respective second portions of the first porous current collector and the second porous current collector.

3. The battery electrode of claim 1, wherein each of the first porous current collector and the second porous current collector is composed of metallic strands that are arranged to form a mesh sheet that defines the multiplicity of interstitial spaces.

4. The battery electrode of claim 3, wherein the metallic strands are fabricated from one of stainless steel or a copper alloy.

5. The battery electrode of claim 4, wherein the metallic strands have circular cross-sections that have been flattened after having been woven into the mesh sheet.

6. The battery electrode of claim 1, wherein the first porous current collector and the second porous current collector comprise respective metallic sheets fabricated from one of stainless steel or a copper alloy, and wherein the interstitial spaces comprise a multiplicity of perforations therein.

7. The battery electrode of claim 6, wherein diameters of the multiplicity of perforations range between 10 microns and 1000 microns.

8. The battery electrode of claim 1, further comprising a first separator arranged on a first side of the battery electrode and a second separator arranged on a second side of the battery electrode.

9. The battery electrode of claim 1, wherein the battery electrode comprises an anode.

10. A method for fabricating a battery electrode, the method comprising:
arranging a lithium foil between a first porous current collector and a second porous current collector, wherein the first porous current collector and the second porous current collector each defines a multiplicity of interstitial spaces;
merging the lithium foil, the first porous current collector and the second porous current collector to embed the lithium foil in the multiplicity of interstitial spaces defined by the first porous current collector and in the multiplicity of interstitial spaces defined by the second porous current collector;
joining the lithium foil, the first porous current collector and the second porous current collector; and
passivating the lithium foil, the first porous current collector and the second porous current collector.

11. The method of claim 10, wherein the first porous current collector and the second porous current collector comprise respective first and second mesh sheets that are composed of woven metallic strands.

12. The method of claim 10, wherein the first porous current collector and the second porous current collector comprise respective first and second sheets fabricated from one of stainless steel or a copper alloy, and wherein the multiplicity of the interstitial spaces comprise a multiplicity of perforations therein.

13. The method of claim 10, wherein merging the lithium foil, the first porous current collector and the second porous current collector comprises compressing the lithium foil between the first porous current collector and the second porous current collector.

14. The method of claim 10, further comprising applying a coating onto the first porous current collector and the second porous current collector prior to arranging the lithium foil between the first porous current collector and the second porous current collector.

15. The method of claim 10, further comprising warming the lithium foil, the first porous current collector and the second porous current collector prior to compressing the lithium foil, the first porous current collector and the second porous current collector, wherein warming comprises heating the lithium foil, the first porous current collector and the second porous current collector to a temperature up to 180 C.

16. The method of claim 10, wherein joining the lithium foil, the first porous current collector and the second porous current collector comprises heating the lithium foil, the first porous current collector and the second porous current collector to a temperature having a range of 180 C to 200 C in an atmosphere that is inert to lithium.

17. The method of claim 10, wherein passivating the lithium foil, the first porous current collector and the second porous current collector comprises coating the lithium foil, the first porous current collector and the second porous current collector with an antioxidant material.

18. The method of claim 10, further comprising arranging a first separator on a first side of the battery electrode and arranging a second separator on a second side of the battery electrode; and compressing the first and second separators and the battery electrode.

19. A method for fabricating a battery electrode, the method comprising:
compressing, via a first pair of opposed rollers, a first mesh sheet composed of woven metallic strands to form a first porous current collector;
compressing, via a second pair of opposed rollers, a first mesh sheet composed of woven metallic strands to form a second porous current collector;
arranging a lithium foil between the first porous current collector and the second porous current collector, wherein the first porous current collector and the second porous current collector each defines a multiplicity of interstitial spaces;
merging the lithium foil, the first porous current collector and the second porous current collector to embed the lithium foil in the multiplicity of interstitial spaces defined by the first porous current collector and in the multiplicity of interstitial spaces defined by the second porous current collector;
joining the lithium foil, the first porous current collector and the second porous current collector; and
passivating the lithium foil, the first porous current collector and the second porous current collector.

20. The method of claim 19, wherein joining the lithium foil, the first porous current collector and the second porous current collector comprises heating the lithium foil, the first porous current collector and the second porous current collector to a temperature having a range between 180 C and 200 C in an atmosphere that is inert to lithium.
